(19) United States
(12) Patent Application Publication
(10) Pub. No.: US 2008/0270219 A1
(43) Pub. Date: Oct. 30, 2008

(54) System and method for conducting surveys and providing alert and related services

(76) Inventor: Ronald R. Antinori, Incline Village, NV (US)

Correspondence Address: MANATT PHELPS AND PHILLIPS;ROBERT D. BECKER, 1001 PAGE MILL ROAD, BUILDING 2, PALO ALTO, CA, 94304, US

(21) Appl. No.: 11/789,990

(22) Filed: Apr. 25, 2007

(51) Int. Cl. G06F 17/30

(52) U.S. Cl. 705/10

(57) ABSTRACT

Preferred embodiments of the present invention are directed to electronic methods and a systems for providing a simple, reliable and secure means for conducting surveys of movie patrons interested in unreleased movies and alerting the patrons when these movies are about to be released. Embodiments of the invention include enrollment, survey and alerting systems and methods using a variety of means and identifying data such as patron fingerprints, ID cards, bar codes and bar code readers. In preferred embodiments, the enrollment step includes having a patron transmit personal information to a central server which stores information on patron preferences. Exemplary embodiments of the survey step include requesting that the enrolled patron input to the server the patron's identifying data and select at least one of the unreleased movie. The alerting step includes notifying the patron of the movie release based on information gathered during the survey process.

### FIELD OF THE INVENTION

Presently, preferred embodiments of the present invention relate to a method and system for conducting surveys of movie patrons having an interest in certain unreleased movies based on trailers, showing at movie theaters as well as posters, standees and other printed promotional materials and alerting the patrons before the release date of these movies.

### BACKGROUND OF THE INVENTION

It is not uncommon to attend a movie today and see four or five previews of coming attractions. Most of these previews are for unreleased movies that will not be available for viewing for weeks to many months in the future. Movie patrons are also exposed to numerous posters, 3-dimensional displays and plasma screens in theater lobbies promoting future films. Some movies will appear in only a limited number of theaters, others in many theaters within a large metropolitan area.

The theater owner or operator has no sure advance way of knowing the possible success or failure of a particular movie. The same holds true for the movie studios that produce these films. Some movies have limited national distribution, others play everywhere.

About one-third of all movies released come from the major studios (2006: 203 from the majors versus 396 from the other distributors). The studios conduct ongoing national research to measure awareness and interest in the movies they are releasing. What they do not have is individual market data of potential patrons expressing interest in a specific film. This is information that can be used by the studios and/or theaters to communicate with these individuals who are seeking more information.

The majority of movies released come from smaller distributors and independent filmmakers who do not have huge advertising and promotion budgets. This creates a greater need for them to be more targeted with their advertisement dollars. Also, there is more pressure on the theaters to generate traffic.

The typical movie patron is barraged with so many previews, posters and displays, especially those that will be released for viewing far into the future. Consequently, a patron will forget that they saw a particular film preview or poster for a movie they have an interest in seeing. As a result, the film may come and go before these patrons see it. With the exception of “art house” theaters, a typical movie patron has no loyalty to a particular theater and will go to the one that is closest, or has the most convenient playing time, or offers the best conveniences, i.e. parking, confectionaries, etc.

Thus, there is a need for a system and method of gathering information on individual patrons having an interest in an unreleased movie and notifying that patron when that particular movie, whose preview they watched and liked, will appear in their local theater. There is a need for such a system to be reliable, secure, and very simple for the patron, and one that uses inexpensive technologies and methods for the distributors and theater operators. There is also a need for using the patron based approach for gathering reliable statistical information about which movies have a high likelihood of success and which patrons, demographically, would most likely attend, on a market by market basis.

### SUMMARY OF THE INVENTION

The present invention solves the problem of providing a simple, reliable, secure method and system for conducting a survey of patrons to determine their interests and providing alerts to the patron. The present system and method also solves the problem of providing key demographic and statistical information on patrons to movie studios, theaters and distributors, etc. without the investment of significant time and resources.

Presently, the preferred embodiment of the present invention contemplates the following three major steps: patron enrollment, survey and alerting. The patron enrollment step includes having a patron that wishes to enroll in the survey transmit personal information including for example, the patron's e-mail address and unique identifying data, such as the patron's fingerprint, or other ID information, to a server. The personal information and identifying data is stored in files of a database storage device of the server. The patron survey or movie selection step includes having the enrolled patron input the patron's identifying data or personal information, and select at least one of the movies that the patron is interested in viewing. This data and selection information is transmitted by the patron for storage in the file created for that particular patron, and stored, for example, in a database server.

In some preferred embodiments of the invention, a patron may wish to enroll by using a fingerprint scanner, bar code reader or a magnetic strip reader which reads a bar code or magnetic strip on a patron's ID card or some other identifying means. In other preferred embodiments of the invention, a user may use a cell phone, PDA, smartphone, or other device with a bar code reader or scanner, which can quickly scan posters or other advertising media which include bar codes or other identifying information, and transmit a patron's personal information or identifying data, for example, through the Internet, by SMS, e-mail, blue tooth, wireless or other communication means to a database server which stores the patron's selection information.

In certain embodiments, the patron alerting step includes notifying the patron from the server via the patron's e-mail address, SMS message, or other means, at an appropriate time, e.g., before the release of the movie in which the patron shows an interest.

### BRIEF DESCRIPTION OF THE DRAWINGS

The foregoing aspects and the attendant advantages of the present invention will become more readily appreciated by reference to the following detailed description, when taken in conjunction with the accompanying drawings, wherein:

FIG. 1 is a block diagram of a preferred embodiment of the system for carrying out the patron enrollment step of the present invention;

FIG. 2 is a functional block diagram depicting preferred embodiments of the patron enrollment step of the present invention; and

FIG. 3 is a functional block diagram depicting preferred embodiments of the patron alert step of the present invention.

### PREFERRED EMBODIMENTS OF DETAILED DESCRIPTION OF THE INVENTION

In the following detailed description of the exemplary embodiments, reference is made to the accompanying drawings that form part hereof, and in which is shown by way of illustration, specific exemplary embodiments in which the invention may be practiced. These embodiments are described in sufficient detail to enable those skilled in the art to practice the invention, and it is to be understood that other embodiments may be utilized and that logical, hardware, software and/or electrical changes may be made without departing from the spirit and scope of the present invention. The following detailed description is therefore not to be taken in a limiting sense.

The present invention is applicable to a variety of industries, including, but not limited to the motion picture industry. The method and system of preferred embodiments of the invention allow a user to enroll in a system that provides alerts and notifications to a patron when that patron is interested in receiving alerts about certain features or products. For example, in exemplary embodiments discussed herein, a patron can enroll for movie notifications by transmitting their personal information and identification information to a central database, which stores information about that user. That patron can then be surveyed in a variety of contexts. For example, a patron can quickly and with minimal effort identify which previews they liked and would like to see when released. Having indicated their preferences upon exiting the theater, for example, or scanning advertisement with a bar code or readable data, the patron would receive an alert reminder message prior to the release of the film(s) chosen. Information concerning the patron's choices and preferences are also stored at databases servers for survey and use by third parties, such as, for example, movie theaters, movie studios and distributors.

In the enrollment step, contemplated in preferred embodiments of the invention, a patron provides his or her identification information to a database on the Internet. The information in this database may be later used to identify the patron. In a preferred embodiment of the system of the present invention, touch-screen monitors and computers are located within a central kiosk or private station in the movie theater or complex of movie theaters to carry out the enrollment step of the present method. Enrollment may be carried out by other means, for example, through a patron's cell phone, PDA or smarpthone.

In addition, a plurality of satellite kiosks or stations is conveniently located throughout the theater or theater complex to carry out the survey step of the present method. In another preferred embodiment of the system of the present invention, these satellites are placed adjacent the exit area of the movie screen that the patron had previously been viewing the trailers and feature film or films.

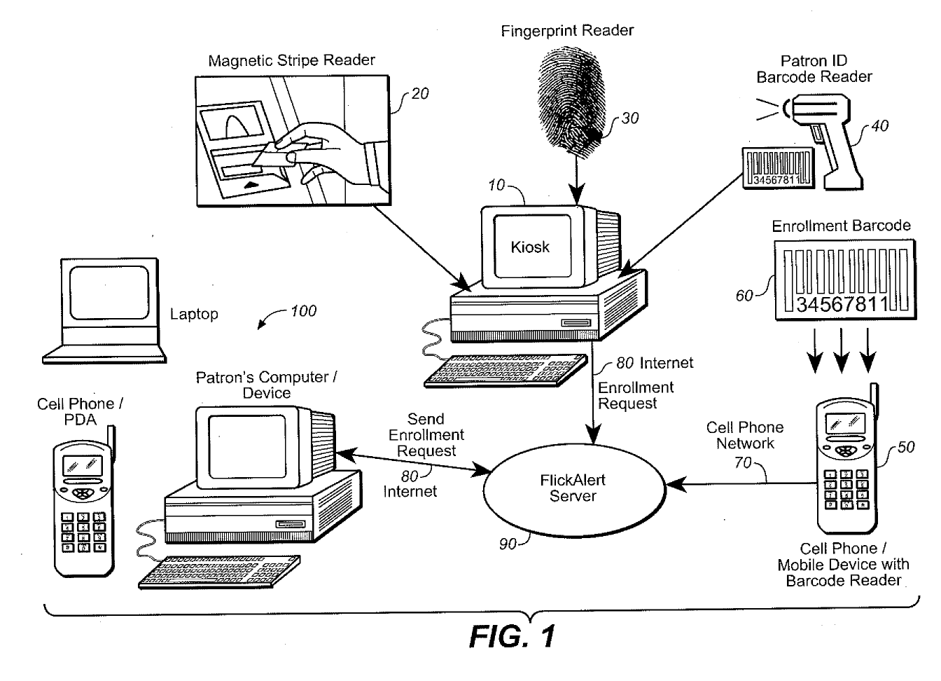

Referring now to FIG. 1, a block diagram is shown of the system for carrying out the enrollment step that occurs at the movie theater once for each patron in the preferred embodiment of the present method. The patron approaches central enrollment kiosk 10 that may include a sign (not shown) identifying what is defined as “the FlickAlert” survey of unreleased movies and requesting patrons to stop in and enroll. The patron may enroll using numerous identification systems and methods, as shown for example, using a Magnetic Strip Reader 20, Fingerprint Reader 30 and Patron ID Barcode Reader 40 and portable device with bar code reader 50. Using various enrollment systems, described in more detail below, a patron can send an enrollment request 80 to a FlickAlert Server 90. A patron may also enroll via a device 100, which may be, for example, a patron's computer, cell phone, PDA, smartphone, laptop, webTV, etc.

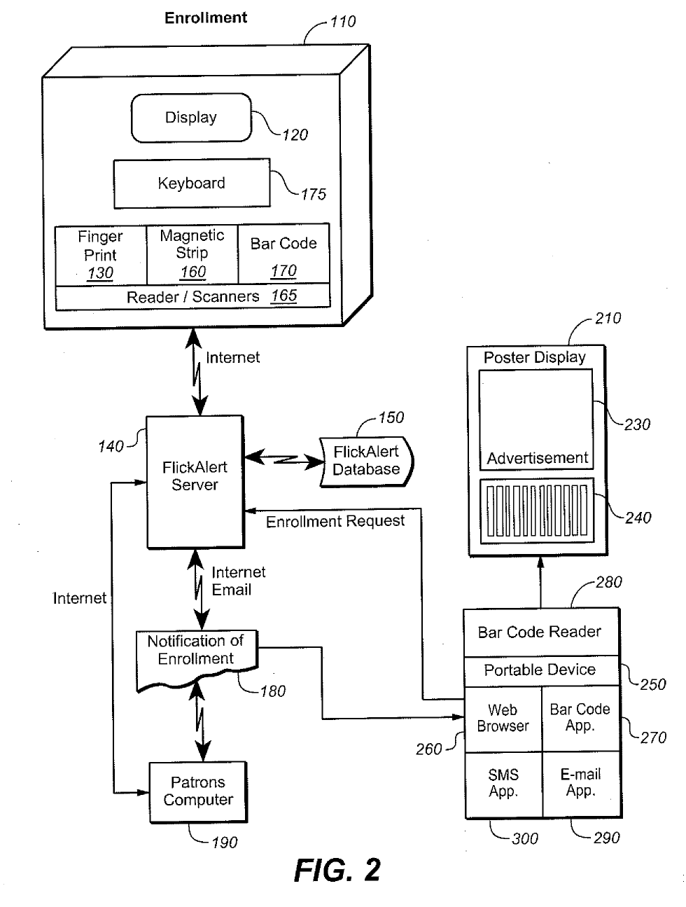

As shown in FIG. 2, in one embodiment of the invention, at a computer kiosk or station 110, the patron uses touch-screen display 120, or some other input means, such as a mouse, etc., to select the identification method from at least one or more of the following methods: keyboard, touch screen input, fingerprint, a magnetic strip card, or barcode. Any number of readers and scanners 165 can be used to derive the personal information and identification information of the patron.

If the patron selects the fingerprint method, the patron places any finger on fingerprint reader 130, which are commercially available from a large number of companies, a few examples of which include Sony, Toshiba, and Digital Persona. One specific example is Digital Persona U are U 4000 Fingerprint Sensor Fingerprint Reader in which the patron simply places a finger on glowing sensor window, and the device quickly and automatically captures the fingerprint image. The applications within kiosk 110 calibrate the device and encrypt the fingerprint image data before sending it to FlickAlert server 140 via the Internet. The image data is stored in FlickAlert database 150.

If the patron prefers to use one of a plurality of identification cards, e.g., driver's license, credit cards, etc., and selects the magnetic strip card method, the patron swipes the card though magnetic strip card reader 160. One example of such a card reader is Manual Swipe Magnetic Card Reader/Writer MSR106 Series. Any acceptable card reader technology may be used. The software within magnetic strip reader 160 will read in the card data, decode and/or decrypt the data if the data is not in a standard ANSI format. The identification data is then transmitted to server 140 and stored in database 150 in a similar manner as that of the fingerprint image data.

An alternate method is for the patron to use the bar code reader 170. This method is used for a patron that has previously obtained a personalized preprinted barcode movie card, or has some identification card with a bar code for storing identification information. The patron swipes the movie card through magnetic strip card reader 160 resulting in the data being sent and stored as described above in connection with the magnetic strip card method. If the patron does not have such a card, the patron keys in the necessary demographic information via keyboard 175 and the card is immediately issued at kiosk 110. In the latter case, there is no necessity during the enrollment step for the patron to use magnetic strip card reader 160 as the information is automatically sent to server 140 and stored in database 150 after the necessary personal information, such as an e-mail address, etc. is keyed into keyboard 175.

In a preferred embodiment of the present system, keyboard 175 includes a magnetic card reader; see, for example, Unitech 2724 keyboard with a built-in magnetic strip reader. During the enrollment step, the patron is requested to enter into keyboard 175 the patron's e-mail address (other personal information may be entered such as patron's name, phone number, cell phone number, residential address, etc.) and hit the submit icon on touch-screen display 120, or by other input means, such as the keyboard or mouse. Immediately after identification data and personal information, such as an e-mail address or phone number is stored in database 150, server 140 assigns a unique Patron ID number to that particular patron and sends notification message 180 to that patron via any suitable communications channels, such as the Internet, wireless or cellular network. The notification (which may comprise an e-mail, SMS message, etc.) may be sent, for example, to a patron's e-mail address or phone number, which can be retrieved, for example on computer 190 which can be any computing system (PC, laptop, etc.), or for example on patron's portable device 250 which may include, for example, a cell phone, PDA, smartphone, or the like. In one embodiment, this is done when the patron hits a meta tag within the notification message 180 that communicates with the FlickAlert's Web site by using any of a number of standard Web browsers, for example, such as Netscape Navigator® and Microsoft Internet Explorer®, web browsers compatible with portable devices, smartphones, cell phones, etc., or any other suitable Internet application, to communicate using standard Internet protocols, such as HTTP/HTTPS, with server 140.

In other embodiments, acknowledgment of receipt of the notification message 180 may be done by sending a reply e-mail message to an e-mail server which is linked to server 140, using standard e-mail protocols (e.g., SMTP) or any other suitable e-mail or messaging protocol which is compatible with the patron's e-mail application on computer 190 or portable device 250. On portable device 250, a patron may use an e-mail application 290 to generate reply and enrollment confirmation e-mails to be sent to the FlickAlert server. An email server, not shown in FIG. 2, may be connected to the web server 140. In another embodiment, server 140 includes an e-mail server for processing e-mail messages and notifications.

In another preferred embodiment, the notification message 180 is sent to the patron via an SMS message. Web server 140 may communicate with a Short Messaging Service Center (SMSC) (not shown) on the network to deliver notifications to the portable device 250 via the wireless network (comprising, e.g. Mobile Switching Centers (MSCs), wireless gateways, etc.). A patron may receive and reply to the SMS message by using an SMS application 300 on portable device 250. The notification method is not limited to any embodiment or figure described or illustrated herein. A patron may receive notifications using any number of modern wireless, Internet, or radio communications protocols and systems.

In one embodiment, the patron may be asked to fill out an enrollment completion form which may be displayed to the user in HTML or any other format which is suitable for the user's web browser or portable device. The patron chooses a password and enters the chosen password. The patron may also enter other demographic data such as the patron's age, sex, nationality, income and the like onto the form. The patron can also indicate on the form certain preferences such as a request that the patron receive a reminder before release of a movie the patron has an interest in and the number of such reminders that the patron wishes to receive on a given movie and other similar information. All of the data for each patron is maintained in a separate file within database 150. Once enrolled the patron has access to the services of the FlickAlert system at any theater that is a FlickAlert subscriber.

In yet another embodiment of the invention, for example, as shown in FIG. 2, a patron may approach a poster display 210, with a movie ad 230 which features a particular movie. The poster may also contain a bar code 240 (e.g., QR code, dot code, ShotCode, SemaCode, Datamatrix, etc.) or other identifying data, which may store information about the movie, the movie theater and web browser links to URLs, such as the FlickAlert website. It should be noted that the medium on which the user reads the bar code or identifying data is not limited to movie posters but can be implemented in other suitable mediums such as magazines, etc. The patron's portable device 250 may have a camera with a built in bar code reader 280 (developed, for example, by Scanbuy and NeoMedia) which allows the patron to capture the bar code image and decode the image using a bar code application 270 on the patron's cell phone or portable device. Such cell phones and portable devices may be available from any number of third parties providing consumer devices with bar code readers, for example, such as Nokia and Motorola. The bar code application 270 will decode the bar code and interact with the user's web browser 260 on the phone or mobile device to present a user with an enrollment form as described above. The user can then quickly enroll in the FlickAlert system via FlickAlert website. Once the patron has enrolled, he or she will receive a notification message 180 as described above. It should also be noted that a patron's identification data may consist of that patron's e-mail address or cell phone number in this alternative embodiment. It is also contemplated that this enrollment process be automatic. For example, application 270 on patron's portable device may enroll patron automatically when the appropriate bar code is scanned. Enrollment, in this situation may comprise transmitting the patron's personal information and identification information, which was previously registered with bar code application 270. After scanning a registration bar code that corresponds to the enrollment process, for example, a patron may be automatically enrolled when the user's bar code application 270 interacts with the user's web browser 260 to send the appropriate commands and data to server 140.

The bar code scanning enrollment method may be implemented with any number of devices, and portable devices, including cell phones, PDAs, laptops, smartphones, etc. Furthermore, the bar code scanning enrollment method is not limited to any particular type of bar code reading or scanning technology and may include, for example, laser or infrared bar code readers in lieu of camera phone bar code readers. Any available third party systems or one developed by FlickAlert, Inc. may be used to implement the bar code scanning system.

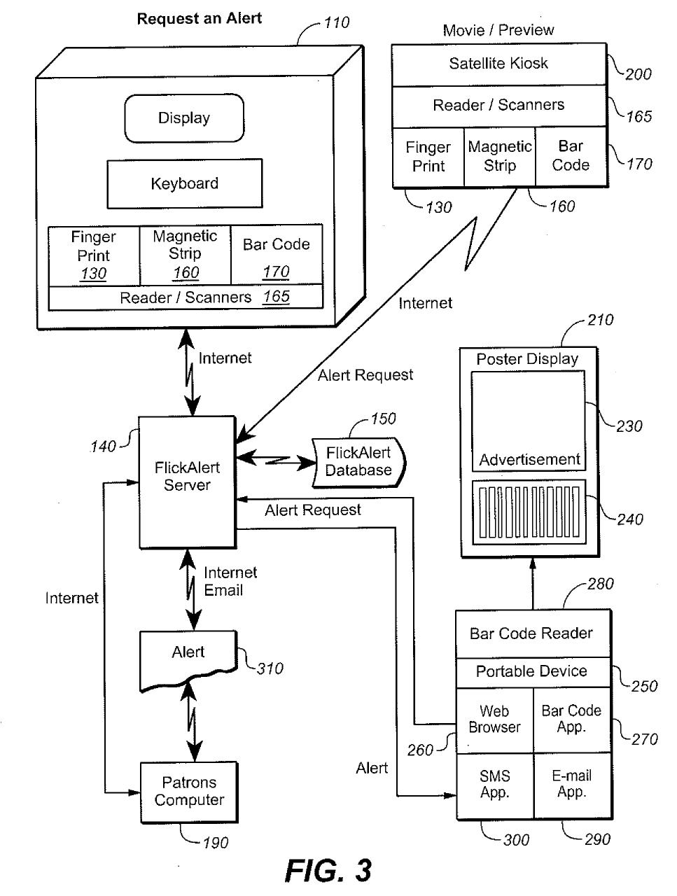

FIG. 3 shows the system for carrying out the patron survey and alerting steps. In one embodiment of the invention, the patron survey occurs either at central enrollment kiosk 110 or at a plurality of satellite kiosks 200 which may feature movie preview posters or the like. Satellite kiosks 200 may also include the same type of identification devices and readers and scanners 165, as in kiosk 110, including, for example, fingerprint reader 130, magnetic strip reader 160, and barcode reader 170. Alerts may also be requested using the bar code scanning method, implementing a portable device 250 with a bar code reader 280. The patron requests a reminder or alert concerning one or more movie releases, which requests may be triggered for example, based on the patron's interest in seeing the future movie and the preview the patron had just seen on a screen in the theater.

At central kiosk 110 or satellite location 200, which may comprise a computer kiosk, the patron selects the “Alert” Web pages from server 140 by user menus which are displayed to the user on display 120 or on computer displays associated with each satellite location 200. The user may request web pages via a touch screen display or other input means such as keyboard or mouse. The called web pages may display graphics or streaming videos of the preview seen by the patron. The patron selects one or more previews in which the patron has an interest. The patron then links the selection with the proper identification using one of the methods that the patron had previously enrolled with. For example, after selecting a movie of interest, the patron may use his fingerprint with fingerprint reader 130, swipe his ID card with magnetic strip reader 160 or use his bar code ID card with bar code reader 170. This will trigger an alert request over the Internet with server 140. Alternatively, the properly enrolled patron presses fingerprint reader 130 using the same finger with which the patron has enrolled or swipes the magnetic or barcode card in reader/scanners 165 and, after being identified, the patron simply selects the previews of interest and then transmits the selection to server 140. The respective file for that patron in database 150 is updated with the alert request and patron and location movie interest.

An alternative to the kiosk system, satellite location 200 may comprise poster stations for each of the respective previews being shown in the theater or theater complex. In this alternative, all a patron is required to do is to use the proper identification device, such as placing the correct finger on the device, at such a poster station to make a selection for that particular movie. Thereafter, that selection is instantly transmitted to server 140 via the Internet and the data is stored in respective file in central database 150. The poster at each station preferably displays both the title of the unreleased movie as well as a scene from the movie that is the same or similar to that in other advertisements and in the theater display cases of coming attractions. If the patron is interested in more than one preview, the next poster station is located and the same method is followed.

In another preferred embodiment, the patron may request an alert for a movie by using portable device with bar code reader 280. In this embodiment, movie posters would be embedded with bar codes (as described above) with links to the server 140 and other URLs of interest. Similar to the mechanism of the enrollment process described above, the user may use his or her portable device bar code reader 280 on the movie poster bar code 290 or other display or advertisement containing a bar code for that movie of interest. The user would then be presented with a URL from the “Alerts” web page which would allow the user to select the movie of choice from the hyperlink presented to the user and transmit an alert request to server 140. This alert request would store requested movie selection in database 150 along with user's other preference information such as location, times, etc. Alternatively, it is contemplated that upon scanning the bar code with the user's bar code reader 280, bar code application 270 on patron's portable device automatically sends the user's movie selection preference via the Internet to server 140. For example, after scanning, application 270 determines the identify of the patron who may be identified by his or her cell phone number or e-mail address (which may be registered with the application) and transmits the patron's identifying information and selection information to server 140, so that the patron may be identified in database 150, patron's information updated, and so that the patron may be alerted in the future using that patron's registered personal information (e.g., e-mail addresses and phone numbers). Using this method, the patron does not have to undertake an additional step of selecting hyperlinks, etc. It should be noted that one of ordinary skill the art, using the present invention, may appreciate may alternative mechanisms for causing alert requests to be transmitted to a server and providing alerts to a patron.

The number of the kiosks, scanners, poster displays and locations would be determined by the theater operator based on several factors including, cost issues, audience sizes, accessibility, ease of use, number of screening rooms, number of previews typically shown, and similar factors. A simple configuration would consist of one PC and one fingerprint scanner centrally located at kiosk 10 or 110. A complex configuration would have not only kiosk 10 or 110 for the enrollment step, but satellite locations 200 next to lobby posters for each of the previews of coming attractions as described above, as well as scanners 165 by each screening room. A fingerprint scanner placed next to a wall mounted lobby poster of the movie advertised is used by having the patrons simply place their fingers in the scanner. A green light on the scanner would indicate proper identification. A red light would mean that they were not identified and must enroll properly as described in the numerous methods above.

Alternatively, if the majority of patron's are employing portable device bar code readers, a more cost efficient deployment configuration for movie theaters and operators may comprise using advertisements with bar codes which would provide the necessary URL links, e-mail addresses, etc. for the patron to enroll and request alerts.

In another embodiment of the system of the present invention, a scanner and a series of push buttons are used to indicate choices of one or more of the unreleased movies that are of interest. These buttons could be associated with the text display of the name of a movie or a small graphical version of a movie poster. The patrons make their selections and then scan their respective fingerprints. This configuration can be used adjacent to the exits of each screening room and be wall mounted.

In one embodiment of the invention, a patron may check his alerts via computer 190 using any web browser or e-mail client. For example, a confirming e-mail may be waiting to thank the patron for using the system and to indicate which movies have been selected in the FlickAlert survey. A week or so before the release of the movies selected, the patron will then receive an e-mail alert on behalf of the theater owner or operator. The alert will contain the theater's logo, name and address, when the movie will play, and links to other services. These e-mails would include meta tag links to the theater's web site, to a movie review, to an embedded streaming video of the preview, and to a method of purchasing tickets.

Alternatively, the user may also receive alerts via portable device 250 which may comprise an e-mail application 290, web browser 260 and SMS application 300. The user may be alerted of upcoming movies on his or her portable device 250 through means of e-mail, SMS or other suitable communications format, which may further contain links to the various other services as described above.

The information gathered by the method and system of the present invention that is stored in central database 150 will contain information, such as, but not limited to, the patron's fingerprint ID, barcode identifying number, ID card identifying number and e-mail address. Preferably database 150 will also contain demographic information about the patrons to the extent they are willing to provide such information, i.e., sex, age, annual income, address, phone number, and similar demographic information.

Alert transactions generated at each of the theaters subscribing to the system will also be stored on central database 150. These transactions may contain the patron's e-mail address, the name of the theater and the movie previewed, and the date and time attended.

The present method provides many benefits to the patrons, the theater owners, and to the movie studio executive. The studio executives will have ongoing feedback as to which previews are well received and the demographics of patrons asking for an alert. Using this information, they can make decisions regarding release dates, where to release, if to release, and methods of advertising. They could decide to bypass the theaters and go straight to video or DVD. The present invention can be used as a method for the patron to purchase the video or DVD based-on e-mails, web links or SMS messages sent to the patron at an appropriate time after availability.

The theater owners or operators could make some of the same decisions. For example, based on responses to the previews, they could decide not to show a particular movie. Also, a theater could offer Frequent Movie Patron awards similar to the airline frequent flyer programs. Points would be awarded each time a patron buys a ticket as a result of an alert. Devices could be wall mounted outside the theater with fingerprint scanners that could be used to purchase tickets. If used, demographics could be tracked regarding those that chose to see a particular movie. The theater builds customer loyalty and customers would tend to utilize the method of the present invention for keeping track of their usage so they would be entitled to these awards, in the form of free or discounted movie tickets or other gifts.

The patrons benefit by being notified by alerts of movies they wish to view. They would also be able to review their pending list and make additions and deletions from their web browsers. By purchasing tickets to a movie as a result of an alert, they would be enrolled in a specific theater's Frequent Movie Patron program which would entitle them to discounts, free tickets and other free gifts. Of course, this is a global system providing the patron access at any location in any city that subscribes to the present method.

While the preferred embodiments of the present invention have been described, these embodiments are not intended to limit the scope of the present invention, which is set forth in the appending claims. Various modifications of the above described embodiments can be made by those skilled in the art after browsing the specification of the subject application. These modifications are within the scope and true spirit of the present invention.

What is claimed is:

1. A method of conducting a survey of patrons for determining interest in unreleased movies comprising the steps of:
(a) having a patron that wishes to enroll in the survey to transmit to a server personal information including unique identifying data on that patron;
(b) storing the personal information and identifying data of each of the patrons in files of a database storage device of the server;
(c) having the enrolled patron input on identifying means linked to the server the patron's identifying data and select at least one of the unreleased movies that the patron is interested in viewing when the movie is released;
(d) transmitting to and storing the data obtained in step (c) in the respective files of the storage device; and
(e) alerting the patron at an appropriate time before the release of the movie in which the patron showed an interest.

2. The method of claim 1, wherein the personal information is the patron's e-mail address.

3. The method of claim 1, wherein the personal information is the patron's cell phone number.

4. The method of claim 1, wherein the identifying data is the patron's fingerprint.

5. The method of claim 1, wherein the identifying data is the patron's magnetic strip card information.

6. The method of claim 1, wherein the identifying data is the patron's bar code movie card information.

7. The method of claim 1, wherein the identifying data is the patron's e-mail address.

8. the method of claim 1, wherein the identifying data is the patron's cell phone number.

9. The method of claim 1, wherein a touch-screen monitor is placed within a movie theater showing at least one feature movie and a selection of previews for unreleased movies for carrying out step (a).

10. The method of claim 1 wherein the alerting in step (e) comprises an e-mail message to the patron.

11. The method of claim 1 wherein the alerting in step (e) comprises an SMS message to the patron.

12. The method of claim 1 wherein step (a) is carried out automatically by a portable device with a bar code reader.

13. The method of claim 1 or 12 wherein step (c) is carried out automatically by a portable device application with a bar code reader.

14. The method of claims 7 or 8 wherein step (c) is carried out automatically by a portable device application with a bar code reader.

15. The method of claim 4, wherein a patron places a finger on a fingerprint reader that transmits the fingerprint data to the respective files of the storage device.

16. The method of claim 4, wherein the selection in step (c) is carried out by means of a touch screen display.

17. The method of claim 5, wherein a patron swipes a credit card through a magnetic card reader that transmits the patron's identifying data to the respective files.

18. The method of claim 6, wherein a patron uses a bar code with a bar code reader to transmit the patron's identifying data to the respective files.

19. The method of claims 4, 5, 6, 7 or 8 wherein the personal information is the user's e-mail address.

20. The method of claims 4, 5, 6, 7 or 8 wherein the personal information is the user's cell phone number.

21. The method of claim 10, wherein the e-mail message alerts the patron when said movie will be shown.

22. A method of conducting a survey for determining interest in unreleased movies comprising the steps of:
(a) having a patron that wishes to enroll in the survey to transmit to a server personal information and unique identifying data on that patron;
(b) storing the personal information and identifying data of each of the patrons in files of a database storage device of the server;
(c) using a portable information device with a bar code reader to read a bar code for a movie advertisement;
(d) retrieving data on the portable device in response to reading the bar code in step (c);
(e) transmitting and storing the data obtained in step (d) in the respective files of the storage device; and
(f) alerting the patron at an appropriate time before the release of the movie in which the patron showed an interest.

23. The method of claim 22, wherein step (a) is carried out by a patron filling out an HTML form on the Internet.

24. The method of claim 22, wherein step (a) is carried out automatically by an application on patron's portable device which retrieves patron's registered personal information in response to patron scanning a bar code and transmits said personal information to said server by invoking an application on said portable device.

25. The method of claim 24, wherein the step (e) is carried out automatically by an application on user's portable device which in response to scanning the bar code for a movie advertisement, and retrieving data in step (d), invokes an application on said portable device to transmit the data in step (e).

26. The method of claim 22, wherein the step of alerting, comprises the step of sending an e-mail message to the patron.

27. The method of claim 22, wherein the step of alerting, comprises the step of sending an SMS message to the patron.

28. The method of claim 22, wherein the data retrieved in step (d) includes movie data.

29. The method of claim 22, wherein the step of transmitting includes sending alert requests to the server.

30. The method of claim 25, wherein the step of alerting, comprises the step of sending an e-mail message to the patron.

31. The method of claim 25, wherein the step of alerting, comprises the step of sending an SMS message to the patron.

32. A system for conducting a survey of patrons for determining interest in unreleased movies comprising:
(a) enrollment means for receiving personal information and unique identifying data on a patron;
(b) selection means for receiving the patron's selection of at least one of the unreleased movies that the patron is interested in viewing when the movie is released;
(c) a server operably linked to a client via communication means to receive the personal information and the identifying data on the patron;
(d) reader means for reading the unique identifying data and transmitting the data to the server; and
(e) a device capable of receiving alerts for movies of interest to the patron.

33. The system of claim 32, wherein said enrollment means is within a central kiosk at a movie theater.

34. The system of claim 32, wherein the personal information includes at least the patron's e-mail address.

35. The system of claim 32, wherein the personal information includes at least the patron's cell phone number.

36. The system of claim 32, wherein the identifying data is the patron's fingerprint.

37. The system of claim 32, wherein identifying data is the patron's magnetic strip card information.

38. The system of claim 32, wherein the identifying data is the patron's bar code movie card information.

39. The system of claim 32, wherein the identifying data is the patron's e-mail address.

40. The system of claim 32, wherein the identifying data is the patron's cell phone number.

41. The system of claim 32, wherein said selection means for receiving the patron's selection is combined with said enrollment means.

42. The system of claim 32, wherein said reader means is combined with said selection means.

43. The system of claim 32, wherein said enrollment means comprises a touch-screen monitor and a keyboard.

44. The system of claim 32, wherein said selection means comprises a bar code reader built into a portable device for reading a bar code associated with a movie advertisement.

45. The system of claim 32, wherein the reader means comprises a magnetic card reader.

46. The system of claim 32, wherein the reader means comprises a bar code reader.

47. The system of claim 32, wherein the reader means comprises a finger print reader.

48. The system of claim 32, wherein said enrollment means comprises a web browser.

49. The system of claim 32, wherein said enrollment means comprises an SMS application on a patron's cell phone.

50. The system of claim 32, wherein said enrollment means comprises an e-mail application.

51. The system of claim 44, wherein the reader means comprises an application for reading identifying data from said portable device.

52. The system of claim 51 wherein the enrollment and selection means are combined.

53. The system of claims 48, 49 or 50, wherein said device is a portable device.

54. The system of claim 51, wherein the patron receives alerts by e-mail.

55. The system of claim 51, wherein the patron receives alerts by SMS message.

56. The system of claim 51, wherein the portable information device includes a web browser for transmitting information based on the patron's selection to said server.

57. A system for conducting a survey of patrons for determining interest in unreleased movies, comprising:
(a) enrollment means for receiving and processing a patron's personal information;
(b) a server on the network capable of receiving commands and data;
(c) a data storage device associated with said server for receiving and storing said patron's personal information;
(d) a portable device with a bar code reader
(e) a bar code associated with a movie advertisement containing movie data;
(f) an application program on said portable device capable of processing said bar code in response to said bar code reader reading said bar code; and
(g) means for transmitting commands and data to said server in response to patron's use of said bar code reader with said bar code.

58. The system of claim 57 comprising a server for sending alerts to said patron to notify said patron of movies of interest.

59. The system of claim 57, wherein said enrollment means comprises a web browser.

60. The system of claim 57, wherein said enrollment means comprises an SMS application.

61. The system of claim 57, wherein said enrollment means comprises an e-mail application.

62. The system of claim 57, wherein said enrollment means comprises using said portable device with said bar code reader to read a registration bar code and transmit said personal information to said server from said portable device.

63. The system of claim 58, wherein said alerts are e-mail messages.

64. The system of claim 58, wherein said alerts are SMS messages.

65. The system of claim 61 further comprising a web browser for transmitting said personal information to said server from said portable device.

66. The system of claim 62 further comprising an application program for processing said registration bar code into commands and data for transmittal to said server.

67. The system of claim 62, comprising a server for sending alerts to said patron to notify said patron of movies of interest.

68. The system of claim 62 further comprising an application program for processing said registration bar code into commands and data for transmittal to said server.
